(19) United States
(12) Patent Application Publication
(10) Pub. No.: US 2011/0310481 A1
(43) Pub. Date: Dec. 22, 2011

(54) POLARIZATION DEVICE, POLARIZATION PLATE AND VIDEO DISPLAY DEVICE HAVING SUPERIOR DURABILITY AND HEAT RESISTANCE

(76) Inventors: Ki-Ok Kwon, Daejeon (KR); Seung-Ae Kim, Gyeonggi-do (KR); Kyun-Il Rah, Daejeon (KR)

(21) Appl. No.: 13/147,555

(22) PCT Filed: Feb. 3, 2010
(86) PCT No.: PCT/KR2010/000672

§ 371 Date: Aug. 2, 2011

(30) Foreign Application Priority Data
Feb. 3, 2009 (KR) 10-2009-0008614

(51) Int. Cl. G02B 5/30

(52) U.S. Cl. 359/487.02

(57) ABSTRACT

Provided are polarizer, polarizing plate, and image display device having excellent durability and heat resistance in which contents of zinc, boron, and iodine in the polarizer are controlled in a specific range. According to an embodiment of the present invention, a polarizer having a value of zinc content (wt %)×boron content (wt %)/iodine content (wt %) in a range of about 0.1 to about 3.0 in all positions in which a depth (D) from a surface to a center of the polarizer is 0≦D≦200 nm, polarizing plate and image display device including the polarizer are provided. The polarizer, polarizing plate, and image display device according to the present invention have excellent durability and heat resistance in which initial cross transmittance and color are maintained and transmittance, degree of polarization, and color are maintained even under high temperature conditions.

### TECHNICAL FIELD

The present invention relates to a polarizer, a polarizing plate, and an image display device having excellent durability and heat resistance, and more particularly, to a polarizer in which contents of zinc, boron, and iodine are controlled to be within a certain range, a polarizing plate, and an image display device having excellent durability and heat resistance.

### BACKGROUND ART

A polarizing plate is used in an image display device such as a liquid crystal display device, an organic electroluminescent (EL) display device, and a plasma display panel (PDP), and both high transmittance and high degree of polarization are required so as to provide images having excellent color reproducibility. This polarizing plate according to the related art is manufactured by dyeing a polyvinyl alcohol film through the use of dichroic iodine, dichroic dyes, or the like, cross-linking the dyed film and then orienting the cross-linked film through a method such as uniaxial stretching or the like.

Recently, image display devices employing a polarizing plate have been used in a television (TV), a monitor, an instrument panel for an automobile, a personal computer, a notebook computer, a personal digital assistant (PDA), a telephone, an audio/video apparatus, as well as in display panels for various office and industrial machines. According to the expansion of application areas of such image display devices, there have been many cases in which the image display devices are in prolonged use under harsh conditions such as high temperature and high humidity. Therefore, excellent durability and heat resistance are required for the image display devices in order to allow them to properly perform their original functions in such harsh conditions.

Durability of a polarizing plate has been typically improved by a method in which a polyvinyl alcohol-based film itself is modified and/or a non-sublimable dichroic dye is used instead of a sublimable iodine-based polarizer. However, in the method of modifying a polyvinyl alcohol-based (hereinafter, referred to as the ‘PVA’) film itself, limitations may be generated, in which a degree of polarization is reduced because iodine or a dichroic dye is not sufficiently adsorbed by a polymer matrix or transmittance is reduced due to the modification of the matrix. In the method of using a non-sublimable dye, there is a limitation in that a sufficient degree of polarization may not be obtained because control of orientation is difficult during stretching of a PVA film.

### DISCLOSURE

### Technical Problem

An aspect of the present invention provides a polarizer having excellent durability and heat resistance.

Another aspect of the present invention provides a polarizing plate and an image display device including a polarizer having excellent durability and heat resistance.

### Technical Solution

According to an aspect of the present invention, there is provided a polarizer having a value of zinc content (wt %)×boron content (wt %)/iodine content (wt %) in a range of 0.1 to 3.0 in all positions in which a depth (D) from a surface to a center of the polarizer is 0≦D≦200 nm.

According to another aspect of the present invention, there is provided a polarizing plate including the polarizer according to an embodiment of the present invention.

According to another aspect of the present invention, there is provided an image display device including the polarizer or the polarizing plate according to an embodiment of the present invention.

### Advantageous Effects

A value of Zn content (wt %)×B content (wt %)/I content (wt %) is controlled to be within a range of 0.1 or more to 3.0 or less at a certain depth of a polarizer as well as a surface of the polarizer, specifically in all positions in which a depth (D) from a surface to a center of the polarizer is 0≦D≦200 nm, such that the polarizer, the polarizing plate and the image display device including the polarizer or the polarizing plate show excellent initial cross transmittance and color, maintain such properties, and have excellent durability and heat resistance by which initially excellent transmittance, degree of polarization, and color are maintained even in the case they are left standing under high temperature conditions.

### Best Mode

Exemplary embodiments of the present invention will now be described in detail.

The inventors of the present invention discovered, from the results of research into polarizers and polarizing plates having excellent durability and heat resistance, that a specific content relationship of zinc, boron, and iodine in the polarizer is highly correlated with durability and heat resistance, and the durability and heat resistance of the polarizer are significantly increased by controlling the specific content relationship of zinc, boron, and iodine, instead of a zinc content itself in the polarizer to improve the durability and heat resistance of the polarizer.

Boric acid, borate, or borax used as a cross-linking agent in the polarizer generates a hydroxyl group (OH) in an aqueous solution, and a polyvinyl alcohol based resin is cross-linked thereby. Also, polyiodies, in which iodine exists as I₅⁻ and I₃⁻, is inserted between cross-linked network structures by means of polyvinyl alcohol and a boron-supplying material. Therefore, it is considered that heat resistance is increased because the higher the content of the boron-supplying material as a cross-linking agent, the stronger the network structure between polyvinyl alcohol and polyiodies will be, and the more deformation of PVA and polyiodies and deterioration and/or sublimation of polyiodies will be prevented after stretchingstretching. However, heat resistant properties will not be infinitely improved even if a boron (B) content is infinitely high, and a side effect of deteriorating initial cross optical properties (initial cross optical properties represents or is understood as degree of polarization) is generated when boron is used excessively. Also, heat resistance, as well as initial cross optical properties, deteriorates when the boron content is excessively low.

In addition, when a content of I⁻ contained in the polarizer is high, a forward reaction of the following Equation 1 is accelerated at high temperatures such that color changes and degree of polarization may be reduced after the polarizer is left standing in high temperatures.

### Equation 1

I⁻+I₅⁻→I₂ +I₃⁻+I⁻

Also, although heat resistance of the polarizer is improved due to the addition of zinc, initial optical properties of the polarizer deteriorate when zinc is added in excess of an appropriate amount. Therefore, the zinc content in the polarizer has to be controlled to an appropriate amount in terms of controlling initial optical properties, durability, and heat resistance of the polarizer.

Contents of zinc, boron, and iodine in the polarizer are related to the initial optical properties of the polarizer, and heat resistance and durability under high temperature conditions, respectively. Thus, the polarizer may have excellent initial optical properties such as initial color and degree of polarization by controlling to satisfy a specific relationship of the contents of the foregoing components in the polarizer, as well as having excellent durability and heat resistance in which changes in the excellent initial optical properties are minimized even when left standing under high temperature conditions. Therefore, in consideration of the foregoing characteristics of the polarizer in the present invention, content relationships among zinc, boron, and iodine in the specific relationship are controlled to satisfy a specific range.

From the results of the foregoing studies, according to an embodiment of the present invention, a polarizer is provided in which a value of Zn content (wt %)×B content (wt %)/I content (wt %) is in a range of 0.1 to 3.0 in all positions in which a depth (D) from a surface to a center of the polarizer is 0≦D≦200 nm.

The polarizer is generally fabricated with a polyvinyl alcohol-based film, and a film formed of a polyvinyl alcohol-based resin or a derivative thereof may be used.

Any polyvinyl alcohol-based derivative may be used as long as it is generally known in the art. Examples of the polyvinyl alcohol-based derivative may be modified polyvinyl alcohol copolymerized with an carboxylic acid or a derivative thereof, unsaturated sulfonic acid or a derivative thereof, or olefin such as ethylene or propylene, etc. However, the polyvinyl alcohol-based derivative is not limited thereto.

A thickness of the polarizer is generally in a range of 20 μm to 34 μm. In order for the polarizer according to an embodiment of the present invention to have excellent initial color and degree of polarization as well as heat resistance, the value of Zn×B/I may be between 0.1 or more and 3.0 or less in all positions in which the depth (D) from the surface to the center of the polarizer is 0≦D≦200 nm. The condition “depth (D)=0” denotes the surface of the polarizer.

According to the results of analysis on the contents of zinc, boron, and iodine components at all positions of the polarizer, although the polarizer having inferior heat resistance has a very large value of Zn×B/I on the surface of the polarizer, because Zn mainly infiltrates through the surface, the large value of Zn×B/I is not maintained to a depth (D) of 200 nm from the surface towards the center of the polarizer. That is, since a typical polarizer has excessive zinc concentrated on the surface, polarization of oriented iodine is destroyed, and thus, initial optical properties deteriorate. Also, since zinc reacts with iodine and boron in a restricted area of the typical polarizer having zinc concentrated on the surface of the polarizer, the typical polarizer has inferior heat resistance to that of a polarizer in which zinc may react with iodine and boron over a wider region.

Alternatively, according to an embodiment of the present invention, it is estimated that in a polarizer having the value of 0.1≦Zn×B/I≦3.0 to a depth (D) of 200 nm from the surface towards the center of the polarizer, a zinc salt, for example, reacts with a boron component in a wider region to form zinc borate. The zinc borate thus formed absorbs and/or blocks the heat provided from the outside to prevent an iodine reaction through Equation 1. Therefore, it is considered that heat resistance of the polarizer is improved.

Thus, the specific content relationship of zinc, boron, and iodine in the polarizer is highly correlated with the heat resistance of the polarizer. The polarizer, in which the value of Zn×B/I is 0.1 or more in all positions in which the depth (D) from the surface to the center of the polarizer is 0≦D≦200 nm, has an excellent initial cross transmittance, and a color is maintained. Also, the polarizer has excellent durability and heat resistance by which transmittance, degree of polarization, and color are maintained under high temperature conditions. When the value of Zn×B/I is more than 3.0, initial optical properties deteriorate. More particularly, that the value of Zn×B/I is more than 3.0 means that the Zn content in the polarizer is excessively large or the I content is excessively small. Meanwhile, initial optical properties deteriorate when the Zn content in the polarizer is large or the I content in the polarizer is small. Therefore, in the polarizer according to the present invention, the value of Zn×B/I is controlled to be within a range of 0.1 to 3.0 at all positions of 0≦D≦200 nm.

The value of Zn×B/I in all positions in which the depth (D) from the surface to the center of the polarizer is 0≦D≦200 nm is measured by an electron spectroscopy for chemical analysis (ESCA) method. The value of Zn×B/I and the contents of zinc, boron, and iodine in the polarizer are obtained by an ESCA method using a photoelectron spectroscope (XPS or ESCA) ESCALAB 250 (VG). Specifically, the value of Zn×B/I in all positions in which the depth (D) from the surface to the center of the polarizer is 0≦D≦200 nm (i.e., to a depth of 200 nm from the surface) is obtained by performing analysis with an ESCA method after etching the polarizer at 0.1 nm/sec to a maximum depth of 200 nm for 2000 seconds.

Meanwhile, according to an embodiment, the value of Zn×B/I is calculated by weights of zinc, boron, and iodine, respectively. However, atomic percentages (at %) of zinc, boron, and iodine at all positions of the actual polarizer are measured, and then the value of Zn×B/I is calculated by converting the atomic percentages into the weight of each elemental component.

The polarizer according to an embodiment of the present invention may be fabricated by the following method to satisfy the foregoing range of the value of Zn×B/I.

The polarizer is generally fabricated by dyeing, cross-linking, stretching stretching, washing, and drying of a stretchedpolyvinyl alcohol-based film. However, dyeing, cross-linking, and stretching operations may be performed individually or at the same time. Also, the sequence of each operation may also vary and the sequence of reaction operations is not fixed.

The dyeing operation is a process of dyeing iodine or a dye to a polyvinyl alcohol-based resin film and is an operation in which the polyvinyl alcohol based resin film is dyed with dichroic iodine molecules or dye molecules.

The dichroic iodine molecules or dye molecules absorb light vibrating in a stretched direction of a polarizing plate and transmit light vibrating in a perpendicular direction to the stretched direction, thereby enabling polarized light having a specific vibration direction to be obtained.

In general, dyeing is performed by immersing a polyvinyl alcohol-based resin film in an iodine solution. In the fabrication of the polarizer according to the present invention, the dyeing operation is performed by immersing a polyvinyl alcohol-based film in a dyeing aqueous solution having a composition in which a concentration of iodine is in a range of 0.05 wt % to 0.2 wt % and a concentration of potassium iodide is in a range of 0.2 wt % to 1.5 wt %, and a temperature range of 20° C. to 40° C., and for example, 20° C. to 35° C. for 150 seconds to 300 seconds.

When the concentration of iodine is less than 0.05 wt % in the dyeing aqueous solution of the dyeing operation, transmittance of the polarizer may be excessively high, and when the concentration of iodine is more than 0.2 wt %, transmittance of the polarizer may be excessively low. Also, when the concentration of potassium iodide is less than 0.2 wt %, iodine does not dissolve properly because an amount of potassium iodide used as a dissolution aid of iodine is insufficient. When the concentration of potassium iodide is more than 1.5 wt %, the solubility of potassium iodide can be problematic and a foreign material may be generated due to a limitation in the solubility of potassium iodide itself with respect to water. When the temperature of the dyeing aqueous solution is less than 20° C., degrees of dissolution of iodine and potassium iodide with respect to water may be lowered and a dyeing rate may be reduced. When the temperature of the dyeing aqueous solution is more than 40° C., iodine may sublime due to high temperatures. Immersion may be performed for 150 seconds or more in order to sufficiently dye the polyvinyl alcohol-based film by the dyeing aqueous solution. Meanwhile, in terms of transmittance of the polarizer, immersion may be performed for 300 seconds or less.

In the cross-linking operation, the iodine molecules or dye molecules are adsorbed into a polymer matrix of the polyvinyl alcohol-based film by a hydroxyl group (OH) generated in the aqueous solution by means of at least one boron-supplying material selected from the group consisting of boric acid, borate, or borax. When the iodine molecules or dye molecules are not properly absorbed into the polymer matrix, a polarizing plate may not perform its original functions due to a decrease in the degree of polarization.

Although a dipping method is generally used for cross-linking, in which a polyvinyl alcohol-based film is immersed in a cross-linking solution including a boron component-supplying material, the cross-linking may be performed by spraying or coating the cross-linking solution on the PVA film.

In the fabrication of the polarizer according to the present invention, the cross-linking operation is performed by immersing a PVA film in a cross-linking solution having a composition, in which the concentration of boron is in a range of 0.36 wt % to 0.83 wt % and the concentration of potassium iodide is in a range of 4 wt % to 7 wt %, and a temperature range of 15° C. to 60° C. for 30 seconds to 120 seconds. When the concentration of boron is less than 0.36 wt % in the cross-linking solution of the cross-linking operation, the cross-linking of the PVA film is not sufficient and initial optical properties and durability may deteriorate. When the concentration of boron is more than 0.83 wt %, the solubility with respect to water may decrease. Examples of the boron component-supplying material may be at least one or more selected from the group consisting of boric acid, borate, or borax. However, the boron component-supplying material is not limited thereto.

Also, in the cross-linking operation, iodine ions may be included in the cross-linking solution by adding potassium iodide or the like to the cross-linking solution. When the cross-linking solution including iodine ions is used, a polarizer having less coloration, i.e., a neutral gray polarizer that provides relatively constant absorbance with respect to all wavelength ranges of visible light, may be obtained. In order to achieve an appropriate neutral gray color, the concentration of potassium iodide in the cross-linking solution may be 4 wt % or more. Meanwhile, when the concentration of potassium iodide is more than 7 wt %, excessive I⁻ is provided by means of potassium iodide and the forward reaction of Equation 1 is accelerated by the excessive I⁻ included in the polarizer at high temperatures such that color changes and the decrease in a degree of polarization are generated after left standing at high temperatures.

When the temperature of the cross-linking solution is less than 15° C., the boron component-supplying material is insufficiently dissolved, and when the temperature of the cross-linking solution is more than 60° C., a reaction of the dissolution of the boron component-supplying material from the film is more prominent than a reaction of the inflow and cross-linking of the boron component-supplying material to the film due to high temperatures. Thus, an appropriate cross-linking reaction may not be generated.

Meanwhile, when the immersion time of the polyvinyl alcohol-based film or the dyed polyvinyl alcohol-based film in the cross-linking solution is less than 30 seconds, cross-linking is not properly achieved because the boron component-supplying material does not sufficiently infiltrate in a depth direction of the PVA film. When the immersion time is more than 120 seconds, initial optical properties of the polarizer deteriorate because cross-linking is excessively performed due to the inflow of the excessive boron component-supplying material to the PVA film.

The stretching operation denotes that a film is stretched along one axis in order for the polymers of the film to be oriented in a certain direction. Since iodine molecules (I₂) or dye molecules are aligned by means of stretching in a direction parallel to a stretching direction to show dichroism, the film will have a function in which light vibrating in the stretched direction is absorbed, and light vibrating in a perpendicular direction to the stretched direction is transmitted.

A stretching method may be classified as a wet stretching method or a dry stretching method. The dry stretching method may include an inter-roll stretching method, a heating roll stretching method, a compressive stretching method, a tenter stretching method, etc. The wet stretching method may include a tenter stretching method, an inter-roll stretching method, etc.

In the present invention, the stretching method is not particularly limited, and any stretching method known in the art may be used. Both of the wet and dry stretching methods may be used, and combinations thereof may be used if necessary.

Stretchingmay be performed in a stretching ratio of 4 to 6 times. When the stretching ratio is less than 4 times, stretching of the PVA film is insufficient, and when the stretching ratio is more than 6 times, the PVA film may be broken or the orientations of the PVA molecules may be misaligned due to excessive stretching. As a result, initial optical properties deteriorate because the orientation of iodine ion species becomes inferior.

The stretching process may be performed together with the dyeing process or the cross-linking process, or performed separately. Also, when the wet stretching is performed separately, the temperature of a stretching bath may be in a range of 35° C. to 60° C., and for example, in a range of 40° C. to 60° C. The temperature of the stretching bath may be in a range of 35° C. to 60° C. in terms of smooth stretching of the PVA film, stretching process efficiency, prevention of film breakage during stretching, etc.

When the stretching process is performed together with the dyeing process, the stretching process may be performed in a dyeing aqueous solution. When the stretching process is performed together with the cross-linking process, the stretching process may be performed in a cross-linking aqueous solution.

Also, when the dyeing process, the cross-linking process or a zinc salt treatment process which will be described later, and the stretching process are performed at the same time, the temperature of the aqueous solution may be selected in a narrower temperature condition overlapping with the temperature of a process performed at the same time. For example, when the cross-linking process and the wet stretching process are performed at the same time, both of the cross-linking and the stretching may be performed at the temperature of a stretching bath aqueous solution in the stretching process.

Meanwhile, when the stretching is performed together with other processes and there is a process particularly desired to be performed smoothly among various processes, conditions of the corresponding process may be followed. Stretching time is not particularly limited, and when the stretching process is performed together with dyeing, cross-linking, a separate zinc salt treatment, or a separate phosphorous compound treatment process, the stretching process may be performed in a time range of the dyeing, cross-linking, separate zinc salt treatment, or separate phosphorous compound treatment process. Although the stretching time is not particularly limited when the wet stretching process is performed separately, stretching may be performed in a time range of 60 seconds to 120 seconds in consideration of the orientation of the PVA film, optical properties of the polarizer, process efficiency, etc.

Meanwhile, the zinc content in the polarizer according to the present invention is controlled by adding a zinc salt in at least one or more operations of dyeing, cross-linking, wet stretching, or in a separate zinc salt treatment operation in relation to the boron and iodine contents to obtain the value of Zn×B/I ranging between 0.1 or more and 3.0 or less in all positions in which the depth (D) is 0≦D≦200 nm in the polarizer. Zinc salt may be added to any operation among at least one operation of dyeing, cross-linking, wet stretching, or in a separate zinc salt treatment operation, and zinc salt may be added to a plurality of operations.

A content of zinc salt in the aqueous solution is in a range of 0.4 wt % to 7.0 wt o, and for example, 0.5 wt % to 6.5 wt %. The content of zinc salt may be 0.5 wt % to 3.0 wt %. When the content of zinc salt is less than 0.4 wt %, an effect of durability improvement is insignificant, and when the content of zinc salt is more than 7.0 wt %, a foreign material may be generated on the surface of the polarizer due to limitations such as solubility. When zinc salt is added to two processes or more, zinc salt may be added in a range of 0.4 wt % to 7 wt % to an aqueous solution of each process.

When the zinc salt treatment is performed together with the dyeing, cross-linking, or wet stretching process, the zinc salt treatment may be performed under conditions (aqueous solution temperature and immersion time) of the dyeing, cross-linking, or wet stretching process.

Also, when zinc salt is treated by a separate process, the separate zinc salt treatment process may be performed in any operation before the washing operation. However, it is most effective to perform the separate zinc salt treatment process just before the washing operation. When the separate zinc salt treatment process is performed, and particularly, when the zinc salt treatment operation is performed as a separate process just before the washing operation, the separate zinc salt treatment process, for example, may be performed by immersing a PVA film in a zinc salt aqueous solution at a temperature range of 15° C. to 40° C. for 20 seconds to 60 seconds in consideration of the solubility of zinc salt, infiltration of zinc salt with respect to the polarizer, process efficiency and optical properties of the polarizer. However, the separate zinc salt treatment process is not limited to the foregoing condition.

Examples of the zinc salt may be zinc chloride, zinc iodide, zinc sulfate, zinc nitrate, zinc acetate, or a mixture of two or more thereof.

Zinc salt may be added to an aqueous solution (e.g., an iodine and potassium iodide aqueous solution in the dyeing operation, and a cross-linking aqueous solution of the cross-linking operation) already prepared in each operation, or may be added during the preparation of the aqueous solution in each operation. Also, zinc salt may be added together with iodine, potassium iodide and/or a boron component-supplying material.

When zinc salt is provided to the polarizer in the dyeing operation and/or cross-linking operation by the addition of zinc salt to the dyeing aqueous solution and/or cross-linking aqueous solution, zinc salt may infiltrate deeper than 200 nm in a depth direction by further diffusing from the surface of the polarizing film to a deeper portion (in a thickness direction) of the polarizer as temperature becomes higher in a temperature range of the dyeing aqueous solution and/or cross-linking aqueous solution.

The washing operation is performed by immersing a dyed, cross-linked and stretched polyvinyl alcohol-based film in pure water of 25° C. to 30° C. such as ion-exchanged water or distilled water for 10 seconds to 30 seconds. When the temperature of the pure water is less than 25° C., dissolution and removal of a foreign material may be insignificant, and when the temperature of the pure water is more than 30° C., dissolution of boron, potassium, zinc, or phosphorous from the PVA film may be excessive. When the immersion time of the polyvinyl alcohol-based film in the pure water is less than 10 seconds, a washing effect is insignificant, and When the immersion time is more than 30 seconds, the dissolution of boron, potassium, zinc, or phosphorous from the PVA film may be excessive.

Washing is performed to remove a foreign material left on the surface of the polarizer after the dyeing, cross-linking, and stretching operations. In the washing operation, the foreign material remaining on the surface of the polarizer is removed as well as the partial removal of boron, iodine, potassium iodide, and zinc salts contained in the polyvinyl alcohol-based film by dissolving them from the polyvinyl alcohol-based film (polarizer) into a washing solution. The longer the immersion time of the polarizer in the washing solution and the higher the temperature of the washing solution, the larger the contents of boron, iodine, potassium iodide and zinc salt dissolved from the polarizer are. As a result, the contents of boron, iodine, potassium iodide and zinc salt remaining in the final polarizer decrease. Particularly, since the contents of boron, iodine, potassium iodide and zinc salt decrease from the surface of the polarizing film by washing as well as the large removal of compounds contained in the surface of the film, the content ratio of Zn×B/I from the surface to a thickness direction will vary. Therefore, the washing may be performed to obtain the value of Zn×B/I ranging between 0.1 or more and 3.0 or less at the depth (D) of the polarizer of 0≦D≦200 nm by immersing the polarizer in pure water at a temperature range of 25° C. to 30° C. for 10 seconds to 30 seconds in consideration of the contents of iodine, potassium iodide, boron component-supplying compound, or zinc salt used in the dyeing and cross-linking operations. Since the control of the material contents in the polarizer will be different when the sequence of the washing operation is changed, the washing operation may be performed just before drying, after the completion of the dyeing, cross-linking, and stretching processes.

A polarizer is obtained by putting the washed PVA film in an oven and performing a drying operation. The drying operation is generally performed in a temperature range of 40° C. to 100° C. for 10 seconds to 500 seconds. When the drying temperature is less than 40° C., drying the moisture remaining in the PVA film is insufficient, such that wrinkles in the film are generated, and initial cross properties deteriorate because a color of the polarizer becomes blue instead of a neutral gray color. Particularly, the polarizer will show a neutral gray color by properly controlling a ratio of the respective iodine ion species through a reaction such as Equation 1. Meanwhile, the foregoing reaction is further accelerated by the heat supplied in the drying process of the PVA film, and the polarizing film may appear nearly bluish, prior to the color adjustment thereof according to the foregoing principle. Therefore, when the temperature of the drying operation is low, the polarizer shows a bluish color because a reaction such as that of the above Equation 1 is not facilitated. As a result, initial cross properties deteriorate.

When the temperature of the drying operation is more than 100° C., the film may be easily broken due to excessive dryness and the initial color of the polarizer becomes red, deviating from a neutral gray. Thus, initial optical properties deteriorate. When the drying time is less than 10 seconds, drying is insufficient, and when the drying time is more than 500 seconds, the film may be easily broken due to excessive dryness, and the initial color of the polarizer becomes red, deviating from a neutral gray. As a result, initial optical properties also deteriorate.

In a method of fabricating the polarizer according to the present invention, the contents of iodine component, potassium iodide, boron component-supplying material, and zinc salt, the temperatures of the dyeing and cross-linking aqueous solutions, and the immersion time, washing temperature, and washing time of the polyvinyl alcohol-based film with respect to the foregoing aqueous solutions may be controlled in the foregoing ranges in at least one or more operations of the dyeing, cross-linking, and stretching operations in order to obtain the value of Zn×B/I in the polarizer ranging between 0.1 or more and 3.0 or less.

A polarizing plate is fabricated by stacking a protective film using an adhesive on one or both sides of the polarizer fabricated by the foregoing method. The protective film is for preventing outer sides of the polarizing plate from being exposed during the performing of processes and functions to prevent the inflow of contaminants and to protect the surface of the polarizing plate.

A material, which is easily prepared as a film base, has a good adhesion with the PVA film (polarizer), and is optically transparent, may be used as a resin film base of the protective film. Examples of the resin film base of the protective film may be a cellulose ester film, polyester film, (polyethylene terephthalate film, polyethylene naphthalate film), polycarbonate film, polyarylate film, polysulfone (including polyestersulfon) film, norbornene resin film, polyolefin film (polyethylene film, polypropylene film), cellophane, cellulose diacetate film, cellulose acetate butylate film, polyvinylidene chloride film, polyvinyl alcohol film, ethylene vinyl alcohol film, polystyrene film, cycloolefin polymer film, polymethylpentene film, polyetherketone film, polyetherketoneimide film, polyamide-based film, fluororesin film, nylon film, polymethylmethacrylate film, polyacetate film, polyacryl film base, etc. However, the resin film base of the protective film is not limited thereto.

Particularly, a cellulose ester film such as a triacetyl cellulose film (TAC film) or cellulose acetate propionate film, polycarbonate film (PC film), polystyrene film, polyarylate film, norbornene resin film, or polysulfone film may be used in consideration of transparency, mechanical properties, no optical anisotropy, etc. The triacetyl cellulose film (TAC film) or polycarbonate film (PC film) may be used because of the ease of film preparation and good processability. For example, the TAC film may be used.

The polarizing plate protective film may be subjected to a surface modification treatment in order to improve adhesion with respect to the PVA based film to which the protective film adheres. Specific examples of the surface treatment may be a corona discharge treatment, a glow discharge treatment, a flame treatment, an acid treatment, an alkaline treatment, an ultraviolet radiation treatment, etc. Also, providing of an undercoat layer may be used. The surface modification process using an alkaline solution among the foregoing treatments modifies a surface of the protective film to be hydrophilic by introducing a —OH group to the hydrophobic protective film such that the adhesion of the protective film with respect to the polarizer increases.

A water-based adhesive is generally used as an adhesive. Any water-based adhesive may be used as long as it is generally used in the art. Examples of the water-based adhesive may be an isocyanate-based adhesive, polyvinyl alcohol-based adhesive, gelatin-based adhesive, vinyl-based latex adhesive, water-based polyurethane adhesive, water-based polyester adhesive, etc. However, the water-based adhesive is not limited thereto. Among the foregoing water-based adhesives, the polyvinyl alcohol-based adhesive may be used. The water-based adhesive may include a cross-linking agent. The foregoing adhesives are generally used as aqueous solutions. Although a concentration of the adhesive aqueous solution is not particularly limited, the concentration of the adhesive aqueous solution is generally in a range of 0.1 wt % to 15 wt %, and for example, 0.5 wt % to 10 wt %. The concentration of the aqueous solution may be in a range of 0.5 wt % to 5 wt %. Also, a coupling agent such as a silane coupling agent or titanium coupling agent, various tackifiers, ultraviolet absorber, antioxidant, or stabilizer such as heat-resistant stabilizer or anti-hydrolysis stabilizer may be additionally combined to the foregoing adhesives.

For example, the polarizer or the polarizing plate on which the protective film adheres to one or both surfaces of the polarizer may be used in a liquid crystal display device, an organic electroluminescent (EL) display device, a plasma display panel (PDP), etc. However, the use of the polarizer or the polarizing plate is not limited thereto.

### Mode for Invention

Hereinafter, the present invention is described in more detail according to Examples. However, the present invention is not limited to the following Examples.

### COMPARATIVE EXAMPLE 1

A 75 μm thick polyvinyl alcohol film was dyed by immersing the film in a dyeing bath containing a dyeing aqueous solution with an iodine concentration of 0.1 wt % and a potassium iodide concentration of 1 wt % at 30° C. for 5 minutes. (A. dyeing operation) the dyed polyvinyl alcohol film was stretched five times by immersing the film in a cross-linking aqueous solution with a potassium iodide concentration of 5 wt % and a boron concentration of 0.64 wt % at 40° C. for 120 seconds. (B. cross-linking and stretching operation) A polyvinyl alcohol polarizer obtained by the foregoing process was put in an oven and dried at 80° C. for 5 minutes. When the drying of the polyvinyl alcohol polarizer was completed, a polarizing plate was fabricated by adhering a 80 μm thick TAC film to both surfaces of the polarizer using a polyvinyl alcohol adhesive and by drying at 80° C. for 5 minutes.

### COMPARATIVE EXAMPLE 2

Except for adding 1.0 wt % of zinc nitrate in the cross-linking and stretching operation (B), a polarizer and a polarizing plate were fabricated using the method of Comparative Example 1.

### COMPARATIVE EXAMPLE 3

Except for adding 4.0 wt % of zinc nitrate in the cross-linking and stretching operation (B), a polarizer and a polarizing plate were fabricated using the method of Comparative Example 1.

### COMPARATIVE EXAMPLE 4

Except for adjusting the iodine concentration to 0.4 wt % and the potassium iodide concentration to 8 wt % in the dyeing operation (A), adjusting the boron concentration to 0.91 wt %, the potassium iodide concentration to 9 wt %, adding 0.16 wt % of zinc chloride and the temperature of the cross-linking aqueous solution to 62° C. in the cross-linking and stretching operation (B), and immersing in distilled water at 15° C. for 1 second in a washing operation (C), a polarizer and a polarizing plate were fabricated using the method of Comparative Example 1.

### COMPARATIVE EXAMPLE 5

Except for adding 0.01 wt % of potassium iodide and 3.0 wt % of zinc chloride in the cross-linking and stretching operation (B), a polarizer and a polarizing plate were fabricated using the method of Comparative Example 1.

### COMPARATIVE EXAMPLE 6

Except for adjusting the iodine concentration to 0.03 wt % in the dyeing operation (A), adjusting the boron concentration to 0.46wt %, a zinc nitrate concentration to 1.0 wt % and the temperature of the cross-linking aqueous solution to 50° C. in the cross-linking and stretching operation (B) and immersing in distilled water at 15° C. for 1 second in the washing operation (C), a polarizer and a polarizing plate were fabricated using the method of Comparative Example 1.

### EXAMPLE 1

Except for performing the cross-linking and stretching operation (B) by adjusting the temperature of the cross-linking aqueous solution to 50° C. and adding 2.0 wt % of zinc nitrate, and then performing the washing operation (C) by immersing in distilled water at 25° C. for 20 seconds, a polarizer and a polarizing plate were fabricated using the method of Comparative Example 1.

### EXAMPLE 2

Except for performing the cross-linking and stretching operation (B) by adjusting the temperature of the cross-linking aqueous solution to 55° C. and adding 3.0 wt % of zinc sulfate, and then performing the washing operation (C) by immersing in distilled water at 25° C. for 10 seconds, a polarizer and a polarizing plate were fabricated using the method of Comparative Example 1.

### EXAMPLE 3

Except for performing the cross-linking and stretching operation (B) by adjusting the temperature of the cross-linking aqueous solution to 55° C., the boron concentration to 0.55 wt % and adding 2.0 wt % of zinc chloride, and then performing the washing operation (C) by immersing in distilled water at 25° C. for 10 seconds, a polarizer and a polarizing plate were fabricated using the method of Comparative Example 1.

### EXAMPLE 4

Except for performing the cross-linking and stretching operation (B) by adjusting the temperature of the cross-linking aqueous solution to 55° C., the boron concentration to 0.46 wt % and adding 2.0 wt % of zinc iodide, and then performing the washing operation (C) by immersing in distilled water at 25° C. for 20 seconds, a polarizer and a polarizing plate were fabricated using the method of Comparative Example 1.

### EXAMPLE 5

Except for adjusting the iodine concentration to 0.12 wt % and the potassium iodide concentration to 1.2 wt % in the dyeing operation (A), adjusting the boron concentration to 0.55 wt %, a zinc acetate concentration to 0.5 wt % and the temperature of the cross-linking aqueous solution to 58° C. in the cross-linking and stretching operation (B), and immersing in distilled water at 25° C. for 10 seconds in a washing operation (C), a polarizer and a polarizing plate were fabricated using the method of Comparative Example 1.

### EXAMPLE 6

Except for adjusting the iodine concentration to 0.12 wt % and the potassium iodide concentration to 1.2 wt % in the dyeing operation (A), adjusting the boron concentration to 0.46 wt %, the zinc nitrate concentration to 6.5 wt % and the temperature of the cross-linking aqueous solution to 60° C. in the cross-linking and stretching operation (B), and immersing in distilled water at 30° C. for 20 seconds in the washing operation (C), a polarizer and a polarizing plate were fabricated using the method of Comparative Example 1.

### EXPERIMENTAL EXAMPLE: HEAT RESISTANCE EVALUATION

The polarizing plates fabricated according to the methods of Comparative Examples 1 to 6 and Examples 1 to 6 were cut to a size of 50 mm×50 mm, and samples were prepared by adhering the cut polarizing plates to glass using an acrylic adhesive. Thereafter, initial optical properties of each polarizing plate, i.e., single transmittance (Ts), cross transmittance (Tc), single color (a, b), and cross color (x, y) were measured. Subsequently, the polarizing plates were left standing in an oven at 100° C. for 500 hours, and then the foregoing optical properties were measured again. Relative variations of ΔL*ab, cross color x, and Tc are presented in the following Table 2 in a comparison of the optical properties before and after heating. Meanwhile, fabrication conditions of the polarizing plates of Comparative Examples 1 to 6 and Examples 1 to 6 are presented in Table 1.

The foregoing optical properties were measured by using a N & K analyzer (N & K Technology Inc.), single transmittance (Ts) and single color (a, b) were measured using one polarizing plate. One polarizing plate was cut in an stretched direction, the other polarizing plate was cut in an cross direction with respect to the stretched direction, and two cut polarizing plates were positioned cross in such a manner that the absorption axes thereof were at 90° with respect to each other and then, cross transmittance (Tc) and cross color (x, y) were measured therefrom.

Variations in heat resistance were calculated as follows.

ΔL*ab=[(L*₅₀₀−L*₀)²+(a*₅₀₀−a*hd 0)²+(b*₅₀₀−b*₀)²]^{0.5}

(Where L*, a*, and b* are color values in a single state and are L*, a*, and b* color values of a Color Space color coordinate system (defined by the CIE in 1976), respectively. These values were measured with one polarizing plate sample by using the N & K analyzer. L*₀, a*₀, and b*₀ are color values of the polarizing plate in an initial single state, and L*₅₀₀, a*₅₀₀, and b*₅₀₀ are color values in a single state measured after left standing in an oven at 100° C. for 500 hours.)

Tc(%)=100×(Tc₅₀₀−Tc₀)/Tc₀

(Where Tc₀ is an initial cross transmittance of each polarizing plate, Tc₅₀₀ is a cross transmittance measured after each polarizing plate was left standing in an oven at 100° C. for 500 hours, and the cross transmittance (Tc) was measured at the same single transmittance value (Ts).)

x(%)=100×(x₅₀₀−x₀)/x₀

(Where x is a color value of two polarizing plates in a cross state. x denotes a color value of xyz chromaticity coordinates and is calculated from cross color values of two polarizing plates using the N & K analyzer. x₀ is a color value of the polarizing plate in an initial cross state, and x₅₀₀ is a color value of the polarizing plate in a cross state measured after having been left standing in an oven at 100° C. for 500 hours.) Relative variation of ΔL*ab=ΔL*ab of Example/ΔL*ab of Comparative Example 1.

Relative variation of Tc=Tc (%) of Example/Tc (%) of Comparative Example 1

Relative variation of x=x (%) of Example/x (%) of Comparative Example 1

TABLE 1

| | | | B. Cross linking & | | | | | |
|---|---|---|---|---|---|---|---|---|
| | A. Dyeing | | stretching operation | | | | | |
| | operation | | | | Zinc | Solution | C. Washing operation | |
| | I₂ | KI | KI | B | salt | temperature | Washing | Temperature |
| | (wt %) | (wt %) | (wt %) | (wt %) | (wt %) | (° C.) | time (s) | (° C.) |
| Comp. Ex. 1 | 0.1 | 1.0 | 5.0 | 0.64 | — | 40 | — | — |
| Comp. Ex. 2 | 0.1 | 1.0 | 5.0 | 0.64 | 1.0 | 40 | — | — |
| Comp. Ex. 3 | 0.1 | 1.0 | 5.0 | 0.64 | 4.0 | 40 | — | — |
| Comp. Ex. 4 | 0.4 | 8.0 | 9.0 | 0.91 | 0.16 | 62 | 1 | 15 |
| Comp. Ex. 5 | 0.1 | 1.0 | 0.01 | 0.64 | 3.0 | 50 | — | — |
| Comp. Ex. 6 | 0.03 | 1.0 | 5.0 | 0.46 | 1.0 | 50 | 1 | 15 |
| Example 1 | 0.1 | 1.0 | 5.0 | 0.64 | 2.0 | 50 | 20 | 25 |
| Example 2 | 0.1 | 1.0 | 5.0 | 0.64 | 3.0 | 55 | 10 | 25 |
| [symbol] | [symbol] | [symbol] | [symbol] | [symbol] | [symbol] | [symbol] | [symbol] | [symbol] |

[symbol]

indicates data missing or illegible when filed

TABLE 2

| | Variations before and after heating | | |
|---|---|---|---|
| | Relative variation | Relative variation | Relative variation |
| | of ΔL*ab | of Tc | of x |
| Comparative | 1.00 | 1.00 | 1.00 |
| Example 1 | | | |
| Comparative | 1.21 | 1.12 | 1.25 |
| Example 2 | | | |
| Comparative | 1.48 | 1.32 | 1.59 |
| Example 3 | | | |
| Comparative | 1.32 | 1.25 | 1.32 |
| Example 4 | | | |
| Comparative | 1.25 | 1.31 | 1.50 |
| Example 5 | | | |
| Comparative | 1.10 | 1.20 | 1.25 |
| Example 6 | | | |
| Example 1 | 0.66 | 0.38 | 0.60 |
| Example 2 | 0.21 | 0.12 | 0.25 |
| Example 3 | 0.40 | 0.23 | 0.31 |
| Example 4 | 0.60 | 0.42 | 0.57 |
| Example 5 | 0.68 | 0.85 | 0.78 |
| Example 6 | 0.20 | 0.15 | 0.32 |

Inorganic Content Analysis

Values of Zn×B/I of the polarizers in Comparative Examples 1 to 6 and Examples 1 to 6 at positions corresponding to depths denoted in Table 4 were measured with an electron spectroscopy for chemical analysis (ESCA) method and are presented in Table 4. The ESCA method was performed by using a photoelectron spectroscope (XPS or ESCA, model: ESCA LAB 250 system (VG)). As shown in Table 3 below, atomic percentages (at %) of zinc, boron, and iodine of the polarizer at positions corresponding to the depths denoted in Table 4 were measured by etching the surface of the polarizer for each step and the value of Zn×B/I was obtained by calculating a weight of each element therefrom. Meanwhile, conditions of the ESCA analyses were as follows.

<ESCA analysis condition>

(1) Total ESCA system condition

Base chamber pressure: 2.5×10⁻¹⁰ mbar

X-ray source: monochromatic Al Kα (1486.6 eV)

X-ray spot size: 400 μm

Lens mode: Large Area XL

Operation mode: constant analyzer energy (CAE) mode

Ar ion etching: etching rate ˜0.1 nm/sec (Mag 10) SiO₂ basis Charge compensation: low energy electron flood gun used, ion flood gun not used.

(2) Etching of the Polarizer

Contents of zinc, boron, and iodine to a depth of 200 nm from the surface of the polarizer were measured by etching the polarizer for the etching time of the following Table 3. 1 nm of the polarizer is etched by etching for 10 seconds. In the present experiment, the contents of zinc, boron, and iodine at each position of the polarizer were measured by etching to a depth of total 200 nm (2000 seconds) in a step denoted as the following Table 3.

TABLE 3

| | Etching time for | Total etching |
|---|---|---|
| Step | each step (second) | time (second) |
| 1 | 0 | 0 |
| 2 | 10 | 10 |
| 3 | 90 | 100 |
| 4 | 100 | 200 |
| 5 | 200 | 400 |
| 6 | 200 | 600 |
| 7 | 200 | 800 |
| 8 | 200 | 1000 |
| 9 | 200 | 1200 |
| 10 | 200 | 1400 |
| 11 | 200 | 1600 |
| 12 | 200 | 1800 |
| 13 | 200 | 2000 |

TABLE 4

| | Zn × B/I | | | | | | | | | | | |
|---|---|---|---|---|---|---|---|---|---|---|---|---|
| Depth | Comp. | Comp. | Comp. | Comp. | Comp. | Comp. | | | | | | |
| (nm) | Ex. 1 | Ex. 2 | Ex. 3 | Ex. 4 | Ex. 5 | Ex. 6 | Ex. 1 | Ex. 2 | Ex. 3 | Ex. 4 | Ex. 5 | Ex. 6 |
| 0 | 0.00 | 0.46 | 0.00 | 4.10 | 2.10 | 4.10 | 0.26 | 0.49 | 0.33 | 0.35 | 0.61 | 0.50 |
| 1 | 0.00 | 1.07 | 8.80 | 5.80 | 6.10 | 7.80 | 0.85 | 0.87 | 0.56 | 0.53 | 1.20 | 0.52 |
| 10 | 0.00 | 0.50 | 1.82 | 3.20 | 5.60 | 5.40 | 0.56 | 0.39 | 0.59 | 0.19 | 1.32 | 0.45 |
| 20 | 0.00 | 0.00 | 1.37 | 0.50 | 0.40 | 1.20 | 0.58 | 0.34 | 0.27 | 0.30 | 1.87 | 0.48 |
| 40 | 0.00 | 0.00 | 0.50 | 0.00 | 0.00 | 0.80 | 0.73 | 0.93 | 0.62 | 0.39 | 1.20 | 0.61 |
| 60 | 0.00 | 0.00 | 0.00 | 0.00 | 0.00 | 0.00 | 0.43 | 0.90 | 0.46 | 0.36 | 0.79 | 1.23 |
| 80 | 0.00 | 0.00 | 0.00 | 0.00 | 0.00 | 0.00 | 0.64 | 0.59 | 0.57 | 0.38 | 0.52 | 1.20 |
| 100 | 0.00 | 0.00 | 0.00 | 0.00 | 0.00 | 0.00 | 0.35 | 0.67 | 0.75 | 0.53 | 0.22 | 1.70 |
| 120 | 0.00 | 0.00 | 0.00 | 0.00 | 0.00 | 0.00 | 0.50 | 0.45 | 0.95 | 0.39 | 0.41 | 2.40 |
| 140 | 0.00 | 0.00 | 0.00 | 0.00 | 0.00 | 0.00 | 0.41 | 0.53 | 1.25 | 0.56 | 0.28 | 2.60 |
| 160 | 0.00 | 0.00 | 0.00 | 0.00 | 0.00 | 0.00 | 0.53 | 1.29 | 1.45 | 0.52 | 0.70 | 2.80 |
| 180 | 0.00 | 0.00 | 0.00 | 0.00 | 0.00 | 0.00 | 0.62 | 1.24 | 0.96 | 0.59 | 0.78 | 1.65 |
| 200 | 0.00 | 0.00 | 0.00 | 0.00 | 0.00 | 0.00 | 0.99 | 1.01 | 0.91 | 0.63 | 0.90 | 1.51 |

As shown in Tables 3 and 4, it may be confirmed that polarizing plates including the polarizers of Examples 1 to 6 having the values of Zn×B/I at the polarizer depth (D) of 0≦D≦200 nm satisfying a range of the present invention have small variations in color values and cross transmittances after heating. Thus, it may be understood that the polarizer and the polarizing plate according to an embodiment of the present invention have excellent durability and heat resistance such that variations in optical properties at high temperatures are small and thus excellent physical properties are secured even under harsh conditions. However, the polarizing plates of Comparative Examples 2 to 6 showing large values of Zn×B/I only at the surface of the polarizers had inferior durability and heat resistance in comparison to the polarizing plates of Examples.

While the present invention has been shown and described in connection with the exemplary embodiments, it will be apparent to those skilled in the art that modifications and variations can be made without departing from the spirit and scope of the invention as defined by the appended claims.

1. A polarizer having a value of zinc (Zn) content (wt %)×boron (B) content (wt %)/iodine (I) content (wt %) in a range of about 0.1 to about 3.0 in all positions in which a depth (D) from a surface to a center of the polarizer is 0≦D≦200 nm.

2. The polarizer of claim 1, wherein zinc is derived from at least one selected from the group consisting of zinc chloride, zinc iodide, zinc sulfate, zinc nitrate, and zinc acetate.

3. The polarizer of claim 1, wherein boron is derived from at least one selected from the group consisting of boric acid, borate, and borax.

4. The polarizer of claim 1, wherein iodine is derived from at least one selected from the group consisting of iodine (I₂) and potassium iodide.

5. The polarizer of claim 1, wherein the value of Zn content (wt %)×B content (wt %)/I content (wt %) in all positions in which the depth (D) from the surface to the center of the polarizer is 0≦D≦200 nm is obtained by using an electron spectroscopy for chemical analysis (ESCA) method through etching the polarizer at about 0.1 nm/sec to a maximum depth of about 200 nm for about 2000 seconds.

6. A polarizing plate comprising the polarizer of claim 1.

7. An image display device comprising the polarizer of claim 1.

8. A polarizing plate comprising the polarizer of claim 2.

9. A polarizing plate comprising the polarizer of claim 3.

10. A polarizing plate comprising the polarizer of claim 4.

11. A polarizing plate comprising the polarizer of claim 5.

12. An image display device comprising the polarizer of claim 2.

13. An image display device comprising the polarizer of claim 3.

14. An image display device comprising the polarizer of claim 4.

15. An image display device comprising the polarizer of claim 5.
